(19) United States
(12) Patent Application Publication
(10) Pub. No.: US 2025/0054672 A1
(43) Pub. Date: Feb. 13, 2025

(54) SELECTIVELY TRANSFERRED INDUCTORS WITH ELECTROPLATED MAGNETIC MATERIAL

(71) Applicant: Intel Corporation, Santa Clara, CA (US)

(72) Inventors: Veronica Aleman Strong, Etterbeek (BE); Neelam Prabhu Gaunkar, Chandler, AZ (US)

(73) Assignee: Intel Corporation, Santa Clara, CA (US)

(21) Appl. No.: 18/366,756

(22) Filed: Aug. 8, 2023

(51) Int. Cl. H01F 17/00; H01F 27/28; H01F 41/04; H01F 41/26

(52) U.S. Cl. CPC H01F 17/0013; H01F 27/2804; H01F 41/046; H01F 41/26; H01F 2017/0066

(57) ABSTRACT

Described herein are inductor devices formed using wafer processing techniques. The inductor devices are singulated and can be mounted into different packages or computing systems. The magnetic material included in the inductor devices have higher aspect ratios (e.g., relatively tall and thin magnetic regions), which may be achieved using electroplating. The electroplated magnetic material is highly concentrated, which enables a higher inductance density.

### TECHNICAL FIELD

This disclosure relates generally to the field of inductor devices, and more specifically, to inductor devices with high aspect ratios achieved through electroplating that can be individually transferred.

### BACKGROUND

Integrated circuit (IC) devices receive power from external sources. High performance microelectronic circuits such as processors, graphics, and memory rely on accurate power delivery to function. Power delivery may be achieved by using integrated voltage converters, which typically include on-package or externally mounted inductors. Fabrication of on-package inductors has typically utilized a paste printing process followed by curing and mechanical drilling. The cured magnetic material is mechanically hard, which leads to a lengthy drilling process which is also expensive (e.g., for replacement drill bits). Additionally, the size of the drill bit determines the critical dimensions of inductors, resulting in inductors that consume a large area.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a flowchart illustrating an example processing method for forming an inductor device, according to some embodiments of the present disclosure.

FIGS. 2A-2L illustrate various steps in the processing method of FIG. 1, according to some embodiments of the present disclosure.

FIG. 3 is a cross-section of another example inductor device that can be formed using a process similar to FIG. 1, according to some embodiments of the present disclosure.

FIG. 4 is a cross-section of another example inductor device that can be formed using a process similar to FIG. 1, according to some embodiments of the present disclosure.

FIG. 5 is a cross-section another example inductor device that has floated magnetic material, according to some embodiments of the present disclosure.

FIGS. 6A and 6B are two example cross-sections of planar inductor, according to some embodiments of the present disclosure.

FIGS. 7A-7C illustrate examples of cylindrical inductors, according to some embodiments of the present disclosure.

FIG. 8 illustrates an example electronics package that includes an inductor device in a recess, according to some embodiments of the present disclosure.

FIG. 9 illustrates an example electronics package that includes two inductor devices on either side of a substrate, according to some embodiments of the present disclosure.

FIG. 10 illustrates an example electronics package that includes two stacked inductor devices, according to some embodiments of the present disclosure.

FIG. 11 illustrates an example electronics package that includes two inductor devices respectively coupled to two dies, according to some embodiments of the present disclosure.

FIGS. 12A and 12B are top views of a wafer and dies that may include or be coupled to one or more inductor devices in accordance with any of the embodiments disclosed herein.

FIG. 13 is a cross-sectional side view of an IC device that may include or be coupled to one or more inductor devices in accordance with any of the embodiments disclosed herein.

FIG. 14 is a cross-sectional side view of an IC device assembly that may include one or more inductor devices in accordance with any of the embodiments disclosed herein.

FIG. 15 is a block diagram of an example computing device that may include one or more inductor devices in accordance with any of the embodiments disclosed herein.

### DETAILED DESCRIPTION

### Overview

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

Described herein are inductor devices that are fabricated using wafer processing tools and techniques. As described above, previous solutions to fabricating inductors within an electronics package relied on magnetic paste, which involved curing the paste and using a mechanical drill to drill through the hardened magnetic material. The critical dimensions of such inductors relied on the drill size, which limits the dimension of inductors that can be formed using this technique. The previous method also limited the inductor configurations that can be made. For example, if a number of voltages are desired in a particular IC package, it can be difficult using existing techniques to include enough inductors to achieve the different voltage levels that are desired.

To overcome the limitations of current on-package inductors, wafer processing techniques and electroplating chemistry are used to form inductor devices with smaller critical dimensions, greater density, and greater design freedom to produce a large variety of inductor devices. In particular, lithographic processes can be used to pattern areas for forming a conductor (e.g., copper regions) and to pattern areas for forming a magnetic material (e.g., cobalt regions). The magnetic material may be grown using electroplating. For example, a seed material (e.g., copper) may be deposited, and a photoresist deposited on top. The photoresist is patterned, and the magnetic material is electroplated over the seed material in the patterned regions.

The magnetic material may have a higher aspect ratio than achievable through prior inductor fabrication techniques. For example, a region of magnetic material may have a height that is at least 5 times greater than the width, or a height that is at least 10 times greater than the width. In addition, the magnetic material is significantly more concentrated than magnetic material mixed with an epoxy to form a paste. A magnetic region formed by electroplating may include, for example, at least 80%, at least 85%, at least 90%, or at least 95% of a ferroelectric element by weight. The high aspect ratios and greater concentration of magnetic material enable higher density inductors compared to prior inductor devices.

As used herein, an inductor device may be a transferable inductive unit, e.g., a die comprising inductors. In some cases, an inductor device is a single transferable inductor. In some cases, an inductor device includes multiple inductors, e.g., an inductor array, where the individual inductors may or may not be coupled together, e.g., in series, in parallel, or a combination. In some embodiments, an inductor device includes additional components, e.g., capacitors or other passive components. In some embodiments, inductors of different topologies (e.g., some in series and some in parallel, or some formed by other processes) can be combined together in a single inductor device or by coupling multiple inductor devices together.

Inductor devices are fabricated over a support structure and a release layer. An inductor device can be separated from the support structure at the release layer (e.g., using a laser). The inductor device can then be transferred to a different electronics device, e.g., a package that includes various components, such as a support structure that also holds one or more dies containing circuitry, such as a logic circuit and/or memory circuit. Inductor devices can be coupled to a package using, for example, hybrid bonding or traditional bonding with solder balls. Using the inductor device fabrication process followed by pick-and-place techniques, it is simpler to include multiple inductors, including multiple different inductors (e.g., inductors that provide different voltages) in a single electronics package. Furthermore, due to the greater density and smaller critical dimensions described above, more inductors and/or inductor devices may be included in a given surface area of a package, and/or a higher inductance can be achieved in a given surface area.

The inductor devices described herein may be implemented in one or more components associated with an IC. In various embodiments, components associated with an IC include, for example, transistors, diodes, power sources, resistors, capacitors, inductors, sensors, transceivers, receivers, antennas, etc. Components associated with an IC may include those that are mounted on an IC or those connected to an IC. The IC may be either analog or digital and may be used in a number of applications, such as microprocessors, optoelectronics, logic blocks, audio amplifiers, etc., depending on the components associated with the IC. The IC may be employed as part of a chipset for executing one or more related functions in a computer.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

In the following detailed description, reference is made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges. The meaning of “a,” “an,” and “the” include plural references. The meaning of “in” includes “in” and “on.”

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. The disclosure may use perspective-based descriptions such as “above,” “below,” “top,” “bottom,” and “side”; such descriptions are used to facilitate the discussion and are not intended to restrict the application of disclosed embodiments. The accompanying drawings are not necessarily drawn to scale. The terms “substantially,” “close,” “approximately,” “near,” and “about,” generally refer to being within +/−20% of a target value, unless specified otherwise. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art. For example, as used herein, a “logic state” of a ferroelectric memory cell refers to one of a finite number of states that the cell can have, e.g. logic states “1” and “0,” each state represented by a different polarization of the ferroelectric material of the cell. In another example, as used herein, a “READ” and “WRITE” memory access or operations refer to, respectively, determining/sensing a logic state of a memory cell and programming/setting a logic state of a memory cell. In other examples, the term “connected” means a direct electrical or magnetic connection between the things that are connected, without any intermediary devices, while the term “coupled” means either a direct electrical or magnetic connection between the things that are connected or an indirect connection through one or more passive or active intermediary devices. The term “circuit” means one or more passive and/or active components that are arranged to cooperate with one another to provide a desired function. In yet another example, a “high-k dielectric” refers to a material having a higher dielectric constant (k) than silicon oxide. The terms “oxide,” “carbide,” “nitride,” etc. refer to compounds containing, respectively, oxygen, carbon, nitrogen, etc.

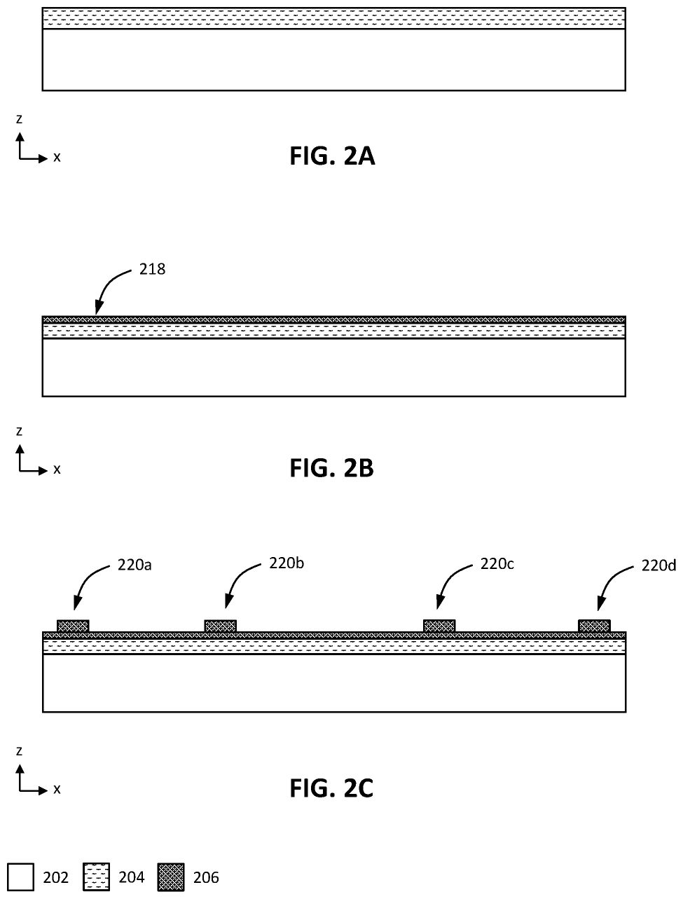

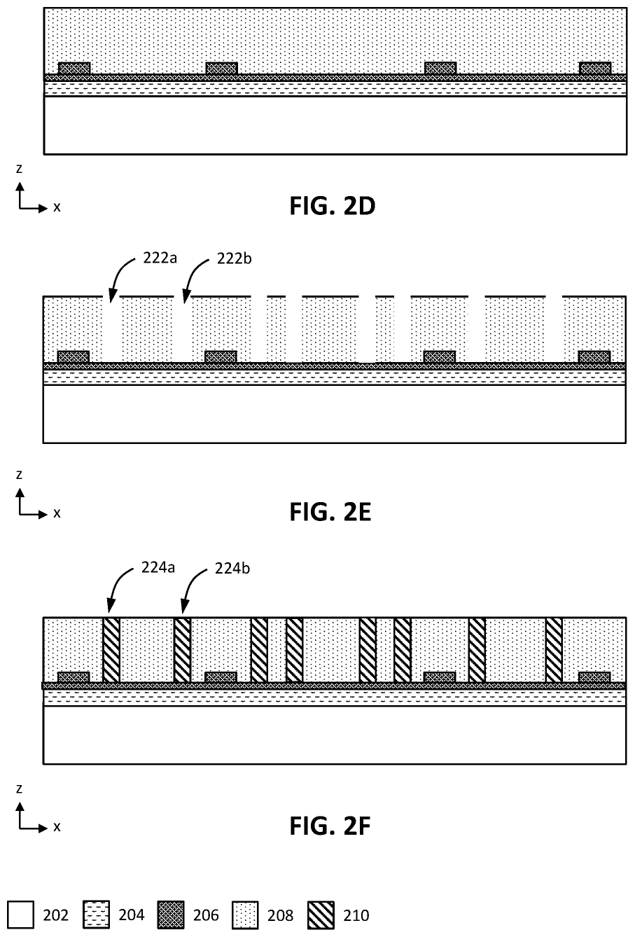

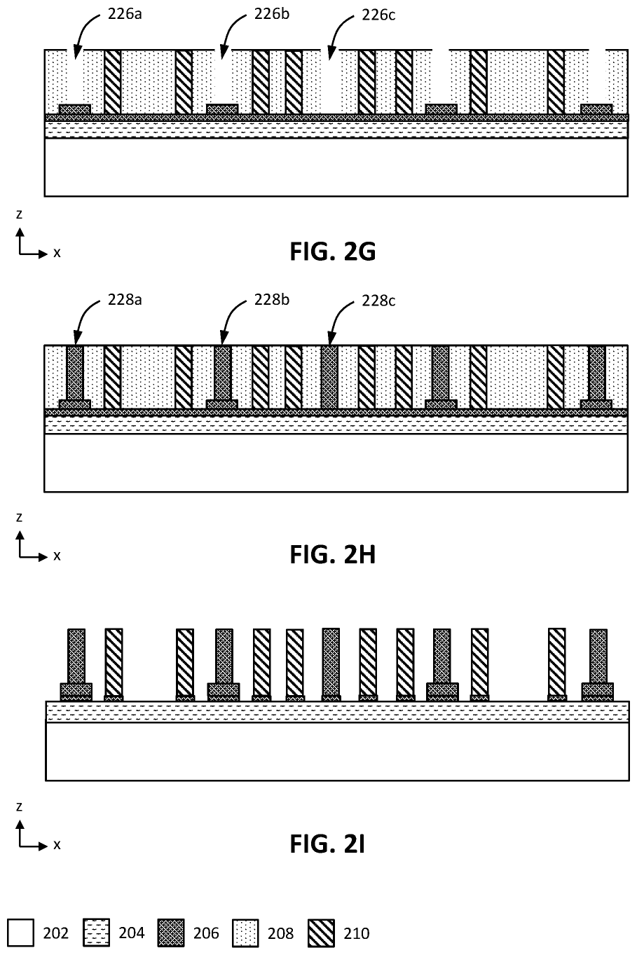

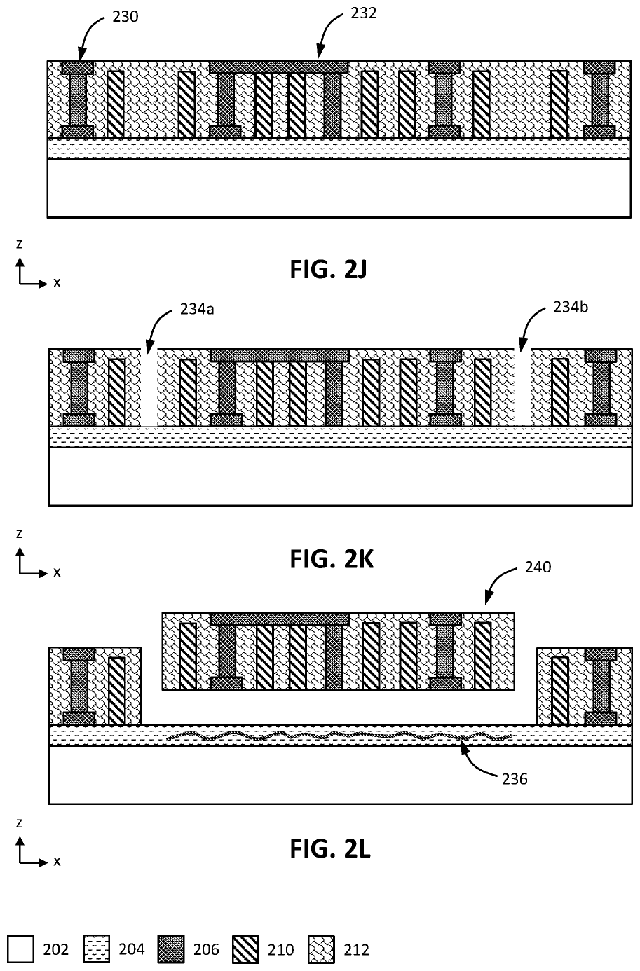

For convenience, if a collection of drawings designated with different letters are present, e.g., FIGS. 2A-2L, such a collection may be referred to herein without the letters, e.g., as “FIG. 2.”

### Example Process for Forming an Inductor Device

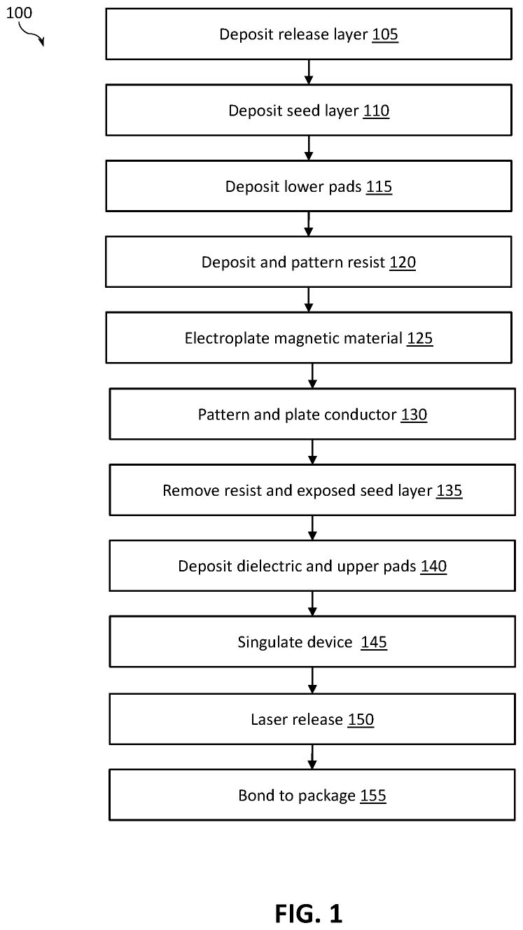

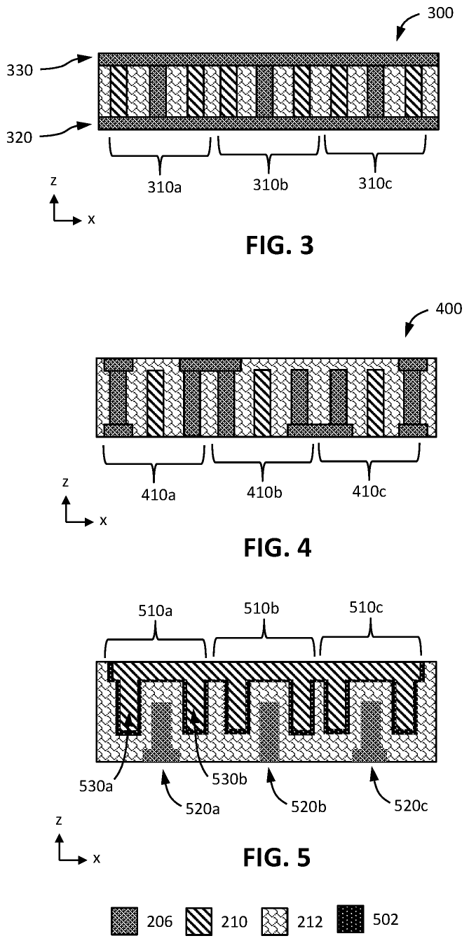

FIG. 1 is a flowchart illustrating an example processing method for forming an inductor device, according to some embodiments of the present disclosure. FIGS. 2A-2L illustrate various steps in the processing method of FIG. 1, according to some embodiments of the present disclosure. In general, the processing method 100 is performed across a support structure (e.g., a wafer), with many individual inductor devices formed on the support structure. The inductor devices may be identical, or may have different designs, e.g., including the design variations described in FIGS. 3-7, for example. FIGS. 2A-2L illustrate cross-sections of processing steps across a particular inductor device, and portions of neighboring inductor devices on the support structure.

A number of elements referred to in the description of FIGS. 2A-2L with reference numerals are illustrated in these figures with different patterns, with a legend at the bottom of the page showing the correspondence between the reference numerals and patterns. For example, the legend below FIGS. 2A-2C illustrates that these figures use different patterns to show a support structure 202, a release layer 204, and a conductive material 206.

In the drawings, some example structures of various devices and assemblies described herein are shown with precise right angles and straight lines, but it is to be understood that such schematic illustrations may not reflect real-life process limitations which may cause the features to not look so “ideal” when any of the structures described herein are examined using e.g., scanning electron microscopy (SEM) images or transmission electron microscope (TEM) images. In such images of real structures, possible processing defects could also be visible, e.g., not-perfectly straight edges of materials, tapered vias or other openings, inadvertent rounding of corners or variations in thicknesses of different material layers, occasional screw, edge, or combination dislocations within the crystalline region, and/or occasional dislocation defects of single atoms or clusters of atoms. There may be other defects not listed here but that are common within the field of device fabrication.

At 105, a process for depositing a release layer over a support structure is performed. To enable finished inductor devices to be removed from a support structure where the inductor devices are fabricated and placed on a destination package, a release layer may be provided. FIG. 2A is a cross-section illustrating a release layer 204 formed over a support structure 202.

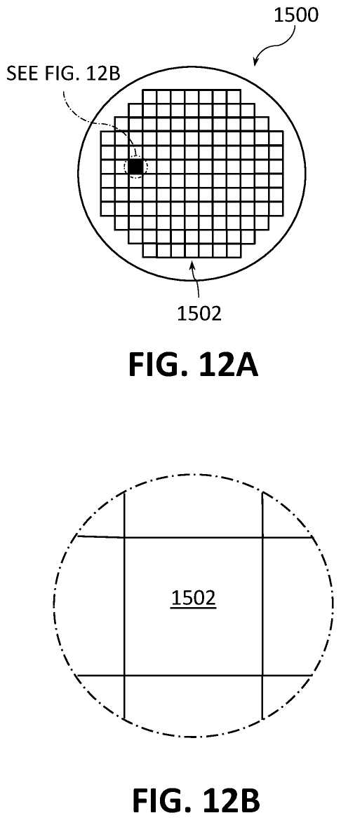

In general, implementations of the present disclosure may be formed or carried out on a support structure, e.g., the support structure 202 illustrated in FIG. 2A. The support structure 202 may be, e.g., a substrate such as a wafer. For example, the support structure may be the wafer 1500 of FIG. 12A, discussed below. The support structure 202 extends along the x-y plane in the coordinate system shown in FIG. 2.

In some embodiments, the support structure may be a substrate that includes silicon and/or hafnium. More generally, the support structure may be a semiconductor substrate composed of semiconductor material systems including, for example, N-type or P-type materials systems. In one implementation, the semiconductor substrate may be a crystalline substrate formed using a bulk silicon or a silicon-on-insulator (SOI) substructure. In other implementations, the semiconductor substrate may be formed using alternate materials, which may or may not be combined with silicon, that include, but are not limited to, germanium, silicon germanium, indium antimonide, lead telluride, indium arsenide, indium phosphide, gallium arsenide, aluminum gallium arsenide, aluminum arsenide, indium aluminum arsenide, aluminum indium antimonide, indium gallium arsenide, gallium nitride, indium gallium nitride, aluminum indium nitride or gallium antimonide, or other combinations of group III-V materials (i.e., materials from groups III and V of the periodic system of elements), group II-VI (i.e., materials from groups II and IV of the periodic system of elements), or group IV materials (i.e., materials from group IV of the periodic system of elements). In some embodiments, the substrate may be non-crystalline. In some embodiments, the support structure may be a printed circuit board (PCB) substrate. In some embodiments, the support structure may be glass. Although a few examples of materials from which the substrate may be formed are described here, any material that may serve as a foundation upon which an inductor device, as described herein, may be built falls within the spirit and scope of the present disclosure.

The release layer 204 is formed atop the support structure 202, e.g., using deposition or another technique, e.g., spin-coating, lamination, etc. The release layer 204 extends along the x-y plane in the coordinate system shown in FIG. 2. The release layer 204 may be a polymer, a metal film, or an oxide, for example. The release layer 204 is selected to form a suitable foundation for forming inductor devices and to enable detachment of the inductor devices after they are formed. In some embodiments, a laser lift-off (LLO) process is used to release inductor devices at the release layer 204, as illustrated and described further below. When a laser is directed at the release layer 204, the material in the release layer 204 absorbs the laser energy and experiences ablation, decomposition, or other structural changes that facilitate the separation.

At 110, a process for depositing a seed layer is performed. The seed layer is a suitable material for electroplating a magnetic material. In general, a seed layer is a thin initial coating of a material (e.g., a metal) that acts as a nucleation site for a subsequent electroplating process. Various deposition techniques can be used to deposit the seed layer, including, e.g., atomic layer deposition (ALD), chemical vapor deposition (CVD), physical vapor deposition (PVD), etc.

FIG. 2B is a cross-section illustrating a seed layer 218 formed over the support structure 202 and over the release layer 204. The seed layer 218 extends along the x-y plane in the coordinate system shown in FIG. 2. The seed layer 218 is formed from a conductive material 206 that may include, for example, copper, titanium, tantalum, iron, ruthenium, cobalt, nickel, or other metals. In some cases, the seed layer 218 can include a combination of metals. In some embodiments, the seed layer 218 is formed from multiple layers of different metals, e.g., a titanium or tantalum base layer, with a copper layer over the base titanium or tantalum layer. The seed layer 218 may have a height in the range of 5-300 nanometers. In this example, the seed layer 218 is deposited directly over the release layer 204. In other examples, one or more intermediate layers (e.g., a dielectric layer) may be formed between the release layer 204 and the seed layer 218.

At 115, a process for depositing lower conductive pads is performed. The conductive pads are formed from a conductive material, e.g., a metal such as copper. The conductive pads may be selectively deposited in certain regions, and in particular, are deposited in areas where conductive structures are formed over top in later processing steps. For example, the conductive pads may be deposited using a lithographic process, e.g., patterning a photoresist and depositing the copper in the patterned regions. The conductive pads enable electrical connections between the inductor device and other structures, e.g., another inductor device, a die, a substrate, etc. In some embodiments, the copper pads are omitted, e.g., if connections to the finished inductor device are on the opposite side of the finished inductor device.

FIG. 2C is a cross-section illustrating four conductive pads 220a, 220b, 220c, and 220d (referred to jointly as conductive pads 220) formed over the seed layer 218. In this example, the conductive pads 220 are formed from the same conductive material 206 as the seed layer 218. In other embodiments, the conductive pads 220 include one or more different materials (e.g., one or more different metals) from the seed layer 218. The conductive pads 220 extend in the y-direction, and may also extend in the x-direction. For example, in a top-down view (looking downwards in the z-direction), the conductive pads 220 may have square, rectangular, circular, or oval shapes. The relative thicknesses of the conductive pads 220 and the seed layer 218 are not to scale in the figures; the seed layer 218 may be significantly thinner than the conductive pads 220. For example, the conductive pads 220 may be at least 10 times or at least 50 times thicker than the seed layer 218. The conductive pads 220 may have a height of, for example, 100 nm-20 μm.

At 120, a process for depositing and patterning a resist is performed. For example, a photoresist is deposited over the seed layer 218 and the conductive pads 220, e.g., using spin coating. The photoresist is then patterned, which changes a physical property of a portion of the photoresist. For example, a patterned mask may be arranged over the photoresist, and some portions of the photoresist are exposed to patterned actinic radiation (e.g., i-line, h-line, or g-line radiation) through the patterned mask. Some portions of the photoresist (either the exposed portions or the non-exposed portions, depending on the chemistry) can then be removed through a developing process to form openings in the photoresist layer.

FIG. 2D is a cross-section illustrating a photoresist 208 formed over the seed layer 218 and conductive pads 220. The photoresist 208 has a thickness at least as large as a desired height of the magnetic material in the inductor device.

FIG. 2E illustrates that regions have been patterned in the photoresist 208. For example, regions 222a and 222b (referred to generally as regions 222) of the photoresist 208 where magnetic material is to be electroplated (as shown in the following step) have been removed. Removing the photoresist 208 in these regions 222 exposes the seed layer 218 below these regions 222. The photoresist 208 may be removed in a developing process, as described above.

At 125, a process for electroplating a magnetic material is performed. The electroplating process may include preparing an electroplating bath, where the bath contains metal ions that are to be plated onto the conductive material 206 of the seed layer 218 in the exposed regions 222. The bath may further include additives, e.g., to control the electroplating process. The support structure is immersed in the electroplating bath, forming an electrochemical cell in which the seed material is the cathode, and the material to be plated is the anode. The seed layer 218 attracts metal ions in the bath, and the metal ions deposit over the exposed regions 222 of the seed layer 218. The metal ions continue to deposit over the seed layer, building up a layer of the metal.

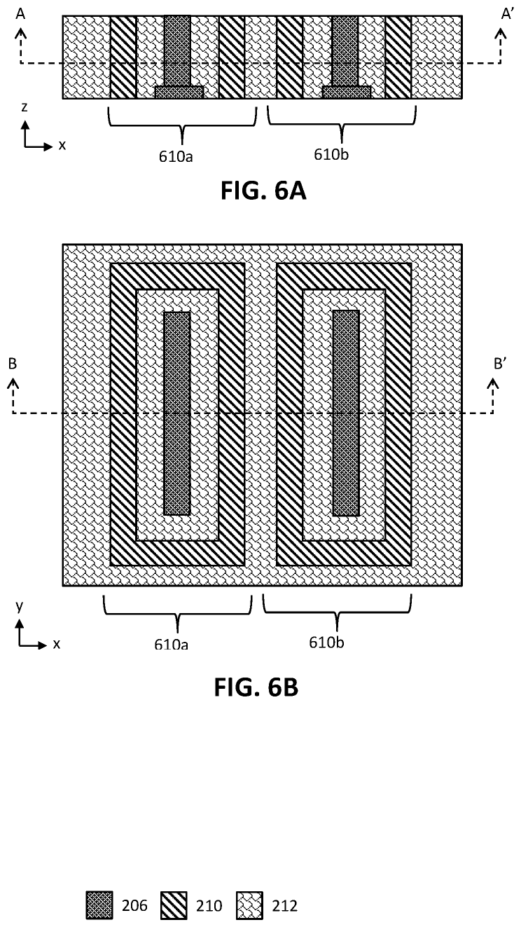

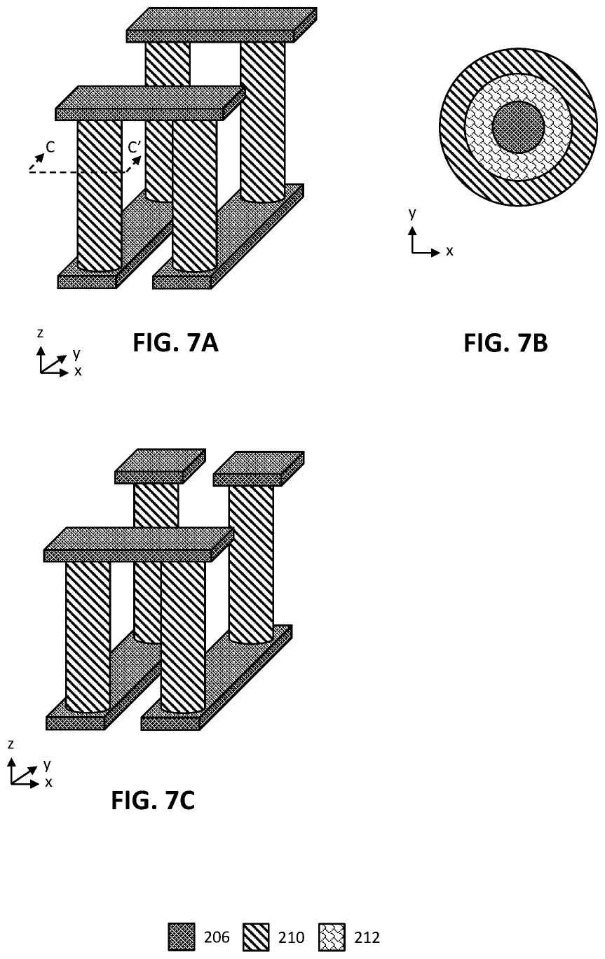

FIG. 2F illustrates a result of the electroplating process. A magnetic material 210 has been deposited in the regions 222, forming magnetic regions. For example, magnetic regions 224a and 224b (referred to generally as magnetic regions 224) have been formed in the regions 222a and 222b. The magnetic regions 224 may have various shapes in cross-section in the x-y plane, e.g., forming planes, rings, or cylinders, as further described with respect to FIGS. 6 and 7.

The magnetic material 210 may include a ferromagnetic element. The magnetic material 210 may include, for example, cobalt, iron, nickel, or a ferromagnetic rare earth metal. The magnetic material 210 is substantially pure, e.g., the magnetic regions 224 may include at least 80%, at least 90%, at least 95%, or at least 99% of a ferroelectric element by weight. In some embodiments, the magnetic material 210 includes a mix of multiple ferroelectric elements, where the ferroelectric elements combined make up at least 80%, at least 90%, etc. of the magnetic regions 224 by weight. This stands in contrast to prior magnetic region formed from a paste, where the ferroelectric element is mixed with an epoxy. Thus, the magnetic regions 224 may not include materials typical of epoxies, such as carbon and oxygen, or only trace amounts of these elements. For example, the magnetic regions 224 may include, by weight, less than 10% of carbon, less than 10% of oxygen, less than 10% of carbon and oxygen combined, or less than 10% of carbon and less than 10% of oxygen. In other examples, the magnetic regions 224 include, by weight, less than 5%, 1%, or 0.5% of carbon and/or oxygen.

At 130, a process for patterning and plating a conductor is performed. Conductor regions may be formed using standard methods for lithography and metal deposition, e.g., as described above with respect to the formation of the lower conductive pads 220. In other embodiments, the conductor regions may be formed using an electroplating process, where a conductor (e.g., copper) is electroplated over exposed regions of the conductive pads and/or seed layer.

FIG. 2G illustrates that regions have been patterned in the photoresist 208. For example, the same photoresist 208 deposited in FIG. 2D has been re-patterned to create additional regions, e.g., regions 226a and 226b (referred to generally as regions 226) in the photoresist 208. Alternatively, the photoresist 208 may be removed and a second photoresist (which may be the same material as the photoresist 208) deposited. Removing the photoresist 208 in the regions 226 exposes portions of the conductive pads, e.g., the regions 226a and 226b are formed over the conductive pads 220a and 220b, respectively. Certain regions 226, e.g., region 226, are not formed over conductive pads. The photoresist 208 may be removed in a developing process, as described above.

FIG. 2H illustrates that a conductor has been deposited in the patterned regions 226. For example, conductive regions 228a, 228b, and 228b (referred to generally as conductive regions 228) have been formed in the regions 226a, 226b, and 226c. The conductive regions 228 may have various shapes in cross-section in the x-y plane, e.g., forming planes, cylinders, or rings, as further described with respect to FIGS. 6 and 7. In this example, the conductive regions 228 are formed from the same conductive material 206 as the seed layer 218 and the conductive pads 220. For example, the seed layer 218, conductive pads 220, and conductive regions 228 may each include copper. In other embodiments, different conductive material may be used.

In the cross-section illustrated in FIG. 2H, the conductive regions 228 and the magnetic regions 224 each extend in parallel to each other in the z-direction. The magnetic regions 224 have a height that extends in the z-direction, i.e., a direction parallel to the conductive regions 228. The magnetic regions 224 may have a height in the range of 1-500 μm, e.g., 1-25 μm, 25-100 μm, 100-200 μm, or 200-500 μm. The magnetic regions 224 further have a width in the x-direction in the coordinate system shown, where the x-direction is perpendicular to the z-direction. The height of the magnetic regions 224 is greater than their width. For example, the height of the magnetic regions 224 may be at least 5 times the width, at least 10 times the width, or at least 15 times the width of the magnetic regions 224. The electroplating process described above enables formation of magnetic regions 224 with such aspect ratios.

The conductive regions 228 may have a height in the z-direction that is the same as or similar to the height of the magnetic regions 224. The conductive regions 228 further have a width extending in the x-direction. The width of the conductive regions 228 is less than a width of the conductive pads 220, where the width of the conductive pads 220 also extending in the x-direction in the orientation shown.

While FIGS. 1 and 2 illustrate the magnetic regions being formed prior to the conductive regions, in other embodiments, these processes may be performed in the opposite order, i.e., the conductive regions may be formed and then the magnetic regions formed.

At 135, the resist and the exposed seed layer are removed. For example, the photoresist 208 is removed through a first chemical process (e.g., a wet etch or a dry etch), and the portions of the seed layer 218 that were under the photoresist 208 are then removed through a second chemical process (e.g., a wet etch or a dry etch).

FIG. 2I illustrates that the seed layer 218 and photoresist 208 have been removed. Portions of the seed layer 218 are still present under the magnetic regions 224, conductive pads 220, and conductive region 228c. In subsequent figures, the remaining portions of the seed layer 218 are not shown, but it should be understood that they may still be present in the inductor device.

The removal of the seed layer 218 may thin the conductive pads 220 and/or the conductive regions 228. However, the seed layer 218 is significantly thinner than the conductive pads 220 and the conductive regions 228, so after removal of the seed layer 218, the conductive pads 220 and the conductive regions 228 remain substantially intact.

At 140, a process to deposit a dielectric material and upper pads is performed. A dielectric material may fill regions between the magnetic regions 224 and the conductive regions 228. Conductive pads may be formed over a portion of the conductive regions 228, to provide routing within the inductor device and/or connection points between the inductor device and one or more other devices.

FIG. 2J illustrates that a dielectric material 212 has been deposited over and around the magnetic regions 224 and conductive regions 228. Suitable dielectric materials 212 may include low-k or high-k dielectrics including, but not limited to, elements such as hafnium, silicon, oxygen, nitrogen, titanium, tantalum, lanthanum, aluminum, zirconium, barium, strontium, yttrium, lead, scandium, niobium, and zinc. Further examples of dielectric materials include, but are not limited to silicon nitride, silicon oxide, silicon dioxide, silicon carbide, silicon nitride doped with carbon, silicon oxynitride, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, tantalum oxide, tantalum silicon oxide, lead scandium tantalum oxide, and lead zinc niobate.

FIG. 2J further illustrates that upper conductor pads have been formed over the conductive regions 228. FIG. 2J includes an upper conductive pad 230 that is similar to the lower conductive pad 220a. FIG. 2J further includes a conductive pad 232 which extends along in the x-direction between the conductive regions 228b and 228c. The conductive pad 232 thus electrically couples the conductive regions 228b and 228c. The conductive pad 232 also extends over two magnetic regions. A thin layer of a dielectric material (e.g., any of the dielectric materials mentioned above) may separate the conductive pad 232 from the underlying magnetic regions.

In general, the inductor device may have different designs (e.g., different arrangements of magnetic regions and conductive regions and different electrical pathways), and the conductive pads 220, 230, and 232 can be arranged based on the design for the particular inductor device. The upper conductor pads 230 and 232 are formed from the same conductive material 206 as the seed layer 218, the conductive pads 220, and the conductive regions 228, e.g., copper. In other embodiments, different conductive material may be used.

At 145, a process to singulate inductor devices formed over the support structure is performed. For example, inductor devices, each corresponding to a respective die, may be individuated from each other using mechanical blade dicing to scribe lines along the boundaries of the dies. As another example, a laser beam may be used to ablate and remove material along the boundaries of the dies. Still other techniques for singulating dies of inductor devices include plasma etching and dry etching.

FIG. 2K illustrates the removal of material to form boundaries 234a and 234b of a particular inductor device. The region between the boundaries 234a and 234b corresponds to one inductor device; regions on the other sides of the boundaries 234a and 234b correspond to portions of neighboring inductor devices. The neighboring inductor devices may similarly be singulated.

At 150, a laser release process is performed. A laser is directed at the release layer, and the release layer undergoes structural changes that facilitate separation of the inductor device from the support structure.

FIG. 2L illustrates a break 236 in the release layer 204, and removal of the inductor device 240 from the support structure 202.

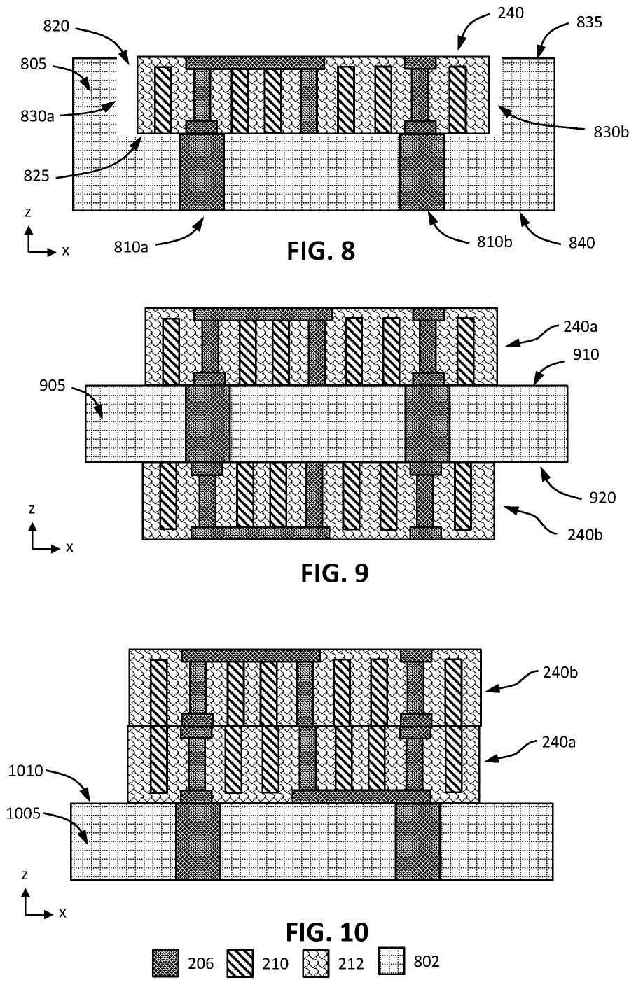

At 155, the released inductor device is bonded to another device package. For example, the inductor device may be attached to another support structure that may also support additional devices or components, such as a die with logic circuits and/or memory circuits. As another example, the inductor device may be attached directly to a die. As still another example, the inductor device may be attached to another inductor device, to form a larger inductor device. Different bonding techniques may be used, such as hybrid bonding, direct bonding, solder bonding, etc. Several electronics packages to which the inductor device can be attached are illustrated in FIGS. 8-11.

### Example Inductor Device Variations

As noted above, the process described in FIG. 1 can be adapted to form inductor devices having different designs. For example, the specific arrangements of the upper conductive pads (e.g., the conductive pads 230 and 232), lower conductive pads (e.g., the conductive pads 220), the electroplated magnetic regions (e.g., the magnetic regions 224), and/or the conductive regions (e.g., the conductive regions 228) may be different in different designs. FIGS. 3-5 illustrate alternate inductor devices that can be produced using the process described above or a variation of this process. It should be understood that these are merely examples, and different types of inductor devices can be formed using the techniques disclosed herein.

FIG. 3 is a cross-section of another example inductor device 300 that can be formed using a process similar to FIG. 1, according to some embodiments of the present disclosure. As noted with respect to FIG. 2J, the inductor device may have different designs, and the conductive pads 220, 230, and 232 can be arranged based on the design for the particular inductor device. In this example, the magnetic regions and conductive regions are arranged to form three inductors 310a, 310b, and 310c. For example, the magnetic and conductive regions may be arranged in cylinders (e.g., as shown in FIG. 7) or extend in the y-direction (e.g., as shown in FIG. 6), and the cross-section illustrated in FIG. 3 is a cross-section through three individual inductors 310a, 310b, and 310c within the inductor device 300. In this example, a lower conductive pad 320 and an upper conductive pad 330 extend across the inductor device 300 in the x-direction. In this example, the inductors 310a, 310b, and 310c are arranged in series, with current passing from the lower conductive pad 320 to the upper conductive pad 330 or vice versa. In some embodiments, the lower conductive pad 320 and the upper conductive pad 330 also extend across the inductor device 300 in the y-direction. While the conductive pads 320 and 330 are illustrated as extending below and above the magnetic material 210, in some embodiments, a dielectric layer under the magnetic material 210 may separate the magnetic material 210 from the lower conductive pad 320 and/or a dielectric layer over the magnetic material 210 may separate the magnetic material 210 from the upper conductive pad 330.

FIG. 4 is a cross-section of another example inductor device 400 that can be formed using a process similar to FIG. 1, according to some embodiments of the present disclosure. In the examples of FIG. 2 and FIG. 3, the outermost region on each of the inductors 310 was a magnetic region, and pairs of the magnetic regions enclosed conductive regions. FIG. 4 illustrates an example of three inductors 410a, 410b, and 410c with an opposite arrangement, where conductive regions are formed around the magnetic regions. FIG. 4 illustrates a further variation for the upper conductive pads and lower conductive pads.

FIG. 5 is a cross-section another example inductor device that has floated magnetic material, according to some embodiments of the present disclosure. In this example, conductive regions 520a, 520b, and 520c are formed over a release layer (not illustrated in FIG. 5). At least a portion of the conductive regions 520 may be formed over conductive pads, e.g., in this example, conductive pads are under the conductive regions 520a and 520c. A dielectric 212 is deposited over the conductive regions 520. The dielectric 212 is patterned and regions of the dielectric 212 are etched to form regions for magnetic material. A seed layer 502 is deposited within the etched portion of the dielectric 212. The seed layer 502 may include any of the seed layer materials described with respect to FIGS. 1 and 2. In this example, the seed layer 502 deposited over the dielectric 212 using a conformal deposition process such as ALD or CVD. Conformal deposition generally refers to deposition of a certain coating on any exposed surface of a given structure. A conformal coating may, therefore, be understood as a coating that is applied to exposed surfaces of a given structure, and not, for example, just to the horizontal surfaces. In other embodiments, a non-conformal deposition process (e.g., PVD) may be used.

The magnetic material 210 is deposited over the seed layer 502 using an electroplating process, as described above. The resulting inductor device includes three inductors 510a, 510b, and 510c, where the conductive regions 520 extend into a region between a pair of magnetic regions, e.g., the conductive region 520a is partially between the magnetic regions 530a and 530b.

### Example Inductors for Inductor Device

In general, an inductor is a passive two-terminal component that stores energy in a magnetic field when an electric current flows through it. A magnetic material can be used to increase the magnetic field and the inductance of the inductor. Inductors are commonly used in power delivery for IC devices to control current and/or voltage levels. For example, inductors can be used to step down an input voltage to a lower output voltage, or to step up an input voltage to a higher output voltage. The individual inductors included in the inductor devices described above may have a variety of different designs. For example, inductors may have a cylindrical shape, with a ring of the magnetic material surrounding a cylinder of the conductive material, or a plane of the conductive material with magnetic material on either side. In either case, a dielectric separates the magnetic material from the conductive material.

FIGS. 6A and 6B are two example cross-sections of planar inductor, according to some embodiments of the present disclosure. FIG. 6B is a cross-section through the plane AA′ in FIG. 6A, and FIG. 6A is a cross-section through the plane BB′ in FIG. 6B. FIGS. 6A and 6B illustrate a pair of inductors 610a and 610b that extend in the y-plane in the coordinate system shown. In particular, the inductors have a planar conductive region formed from the conductive material 206 that extends primarily in the y-direction as well as upwards in the z-direction, and a pair of magnetic regions formed from the magnetic material 210 that are in parallel to the planar conductive region (at different locations in the x-direction). As shown in FIG. 6B, the magnetic regions connect at either end of the conductive region, forming a loop.

FIGS. 7A-7C illustrate examples of cylindrical inductors, according to some embodiments of the present disclosure. FIG. 7B is a cross-section through the plane CC′ in FIG. 7A. FIGS. 7A and 7C each illustrate four inductors, each of which has an internal structure illustrated in FIG. 7B. In particular, each inductor includes the conductive material 206 surrounded by a ring the dielectric material 212, which is further surrounded by a ring the magnetic material 210. The four inductors in each of FIGS. 7A and 7C are further surrounded by additional dielectric 212, not illustrated in FIG. 7.

FIGS. 7A and 7C illustrate two different arrangements of conductive pads formed at the tops and bottoms of the inductors. In FIG. 7A, the inductors are connected in parallel. In FIG. 7C, the inductors are connected in series. More or fewer inductors may be included in a given inductor device, and the inductors may be connected in different arrangements. Furthermore, while examples of planar and cylindrical inductors are shown, it should be understood that different inductor shapes may be fabricated, e.g., oblong, octagonal, square, etc.

### Example Electronics Packages with Inductor Device(s)

As described above, the inductor devices can be transferred and bonded to an electronics package. For example, the inductor devices described herein may be bonded to a glass substrate, a silicon wafer, organic packaging, a mother board, another inductor device, or other materials. Different types of bonding may be used to attach the inductor devices to a substrate or another device. For example, direct bonding or hybrid bonding may be used.

Direct bonding includes metal-to-metal bonding techniques, e.g., copper-to-copper bonding, or other techniques in which bonding contacts of opposing bonding interfaces are brought into contact first, then subject to heat and compression. Hybrid bonding includes techniques in which bonding dielectric of opposing bonding interfaces, possibly first subjected to prior surface activation, are brought into contact first, then subject to heat and sometimes compression, or techniques in which the bonding contacts and the bonding dielectric, possibly first subjected to prior surface activation, of opposing bonding interfaces are brought into contact substantially simultaneously, and the subject to heat and sometimes compression. The materials of opposing bonding dielectrics can be homogeneous (i.e., have substantially the same material composition) or non-homogeneous (i.e., have different material compositions).

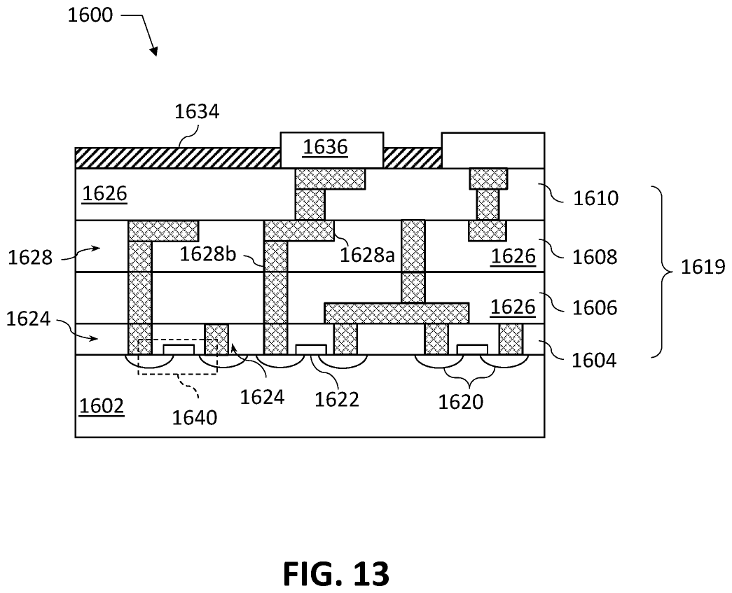

In other embodiments, other methods of bonding may be used, including the use of adhesives (e.g., organic adhesives) and/or solder bonds. Solder bonds between components are described with respect to FIG. 13.

If an inductor device is mounted into a substrate, the substrate may include routing or redistribution layers (RDLs) to couple the inductor device to one or more other components embedded into or mounted on the substrate. If an inductor device is mounted onto another inductor device, the two inductor devices, and in particular, the magnetic regions and/or the conductive regions, may be connected via stacked configuration, which vertically increases the density of the inductors. Additionally, it is also possible to increase the aspect ratio of magnetic inductors by stacking two or more devices. It should be noted, that any number of inductor devices can be incorporated into a package and/or substrate. It should also be noted that it is possible to heterogeneously combine different types of inductor devices, e.g., devices with different configurations of inductors, different numbers of inductors, different inductances, etc. Furthermore, different passive devices (e.g., capacitors, transformers) may be included in an inductor device and/or coupled to an inductor device in a package.

FIGS. 8-11 illustrate example electronics packages that include one or more inductor devices. While the example inductor device 240 from FIG. 2 is shown in the example packages in FIGS. 8-11, it should be understood that any of the inductor devices described herein (e.g., any of the inductor devices in FIGS. 3-7) may be included in the electronics packages illustrated in FIGS. 8-11.

FIG. 8 illustrates an example electronics package that includes an inductor device in a recess, according to some embodiments of the present disclosure. FIG. 8 includes a substrate 805 with a recess 820 formed therein. The inductor device 240 is mounted to the substrate 805, and in particular, within the recess 820 of the substrate 805. The substrate 805 is formed from a substrate material 802 that may be, for example, a silicon wafer, a glass substrate, or any other support structure described herein. In the illustrated cross-section, the recess 820 has a base 825 and two sides 830a and 830b. The base 825 of the recess 820 is below an upper face 835 of the substrate 805 and above a lower face 840 of the substrate 805. The sides 830a and 830b of the substrate 805 are approximately the same height (measured in the z-direction) as the inductor device 240. In other embodiments, the sides 830a and 830b may have heights that are less than the height of the inductor device 240, i.e., the inductor device 240 extends above the substrate 805. Alternatively, the sides 830a and 830b may have heights that are greater than the height of the inductor device 240, i.e., the inductor device 240 is further recessed in the substrate 805 than shown in FIG. 8.

The substrate 805 further includes two vias 810a and 810b, e.g., through substrate vias (TSVs). Conductive pads on in the inductor device 240 are electrically coupled to the vias 810, e.g., by direct bonding, hybrid bonding, or solder bonds. The vias 810 route signals to or from the inductor device 240 to different components (not shown in FIG. 8) that are formed in, formed on, or coupled to the substrate 805, e.g., to other dies (e.g., transistor-based IC devices) mounted on the substrate 805, or to logic devices (e.g., transistors) formed on the substrate 805. In other examples, rather than the TSVs 810, one or more metal routing layers are formed below the base 825 of the recess 820 to route signals to and/or from the inductor device 240.

FIG. 9 illustrates an example electronics package that includes two inductor devices on either side of a substrate, according to some embodiments of the present disclosure. In this example, one inductor device 240a is mounted on an upper face 910 of a substrate 905, and a second inductor device 240b is mounted on a lower face 920 of the substrate 905. The substrate 905 is formed from the substrate material 802. Each of the inductor devices 240 may be bonded to the substrate 905 using any suitable technique, e.g., the bonding techniques described herein. The substrate 905 includes two TSVs, similar to the TSVs 810 in FIG. 8. The TSVs are each coupled to conductive pads of the respective inductor devices 240a and 240b, thus electrically coupling the two inductor devices 240a and 240b together. The inductor devices 240a and 240b may together act as a single device with a larger inductance. In other embodiments, two or more inductor devices may be mounted on a substrate without being coupled to each other, e.g., one inductor device may be coupled to a first logic die (e.g., to provide power regulation for the first logic die), and a second inductor device may be coupled to a second logic die (e.g., to provide power regulation for the second logic die).

In this example, the inductor devices 240a and 240b have the same size, shape, materials, and design (e.g., in the cross-section shown, the same pattern of magnetic regions, conductive regions, and conductive pads). The inductor device 240b is flipped relative to the inductor device 240a. In other embodiments, two different inductor devices (e.g., inductor devices with different sizes, shapes, materials, inductances, number of inductors, arrangement of inductors, and/or types of inductors) may be bonded to a substrate or included in a single electronics package.

FIG. 10 illustrates an example electronics package that includes two stacked inductor devices, according to some embodiments of the present disclosure. In this example, a first inductor device 240a is mounted on an upper face 1010 of a substrate 1005. The substrate 1005 is formed from the substrate material 802. The inductor device 240a may be bonded to the substrate 1005 using any suitable technique, e.g., the bonding techniques described herein. The substrate 1005 includes two TSVs, similar to the TSVs 810 in FIG. 8. The TSVs may couple the inductor device 240a to different components (not shown in FIG. 10) that are formed in, formed on, or coupled to the substrate 1005, e.g., to other dies (e.g., transistor-based IC devices) mounted on the substrate 1005, or to logic devices (e.g., transistors) formed on the substrate 1005.

A second inductor device 240b is mounted to the first inductor device 240a. The inductor device 240b may be bonded to the inductor device 240a using any suitable technique, e.g., the bonding techniques described herein. In this arrangement, the inductor devices 240a and 240b are arranged such that the magnetic regions in the two inductor devices 240a and 240b are in contact with each other, and the conductive regions in the two inductor devices 240a and 240b are also in contact with each other. The two inductor devices 240a and 240b may thus behave as a single inductor device with magnetic regions that have an even greater aspect ratio than the individual inductor devices 240a and 240b. For example, if each inductor device 240a and 240b has magnetic regions that are 100 μm tall, the stacked inductor device has magnetic regions that are 200 μm tall.

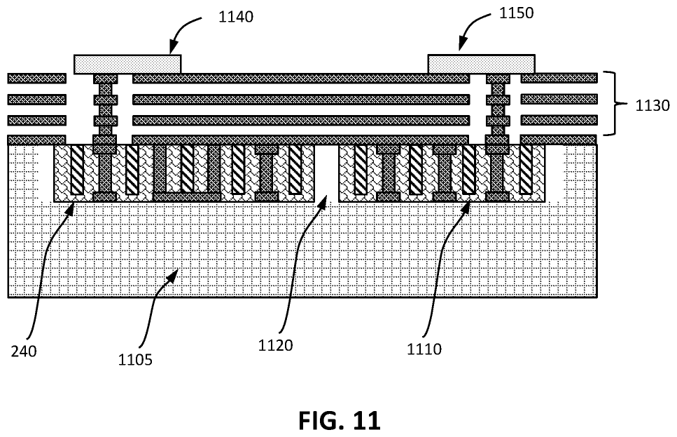

FIG. 11 illustrates an example electronics package that includes two inductor devices respectively coupled to two dies, according to some embodiments of the present disclosure. In this example, a first inductor device 240 and a second inductor device 1110 are mounted in a recess 1120 of a substrate 1105. The substrate 1105 is formed from the substrate material 802. The recess 1120 is similar to the recess 820 described with respect to FIG. 8, except that here, the recess 1120 is sized to fit the two inductor devices 240 and 1110. The inductor devices 240 and 1110 may be bonded to the substrate 1105 (and in particular, the base of the recess 1120) using any suitable technique, e.g., the bonding techniques described herein. In this example, the inductor devices 240 and 1110 are different; for example, they have different sizes (e.g., different lengths in the x-direction) and different layouts of magnetic regions, conductive regions, and conductive pads. The inductor devices 240 and 1110 may provide, for example, different inductances or different numbers of inductors.

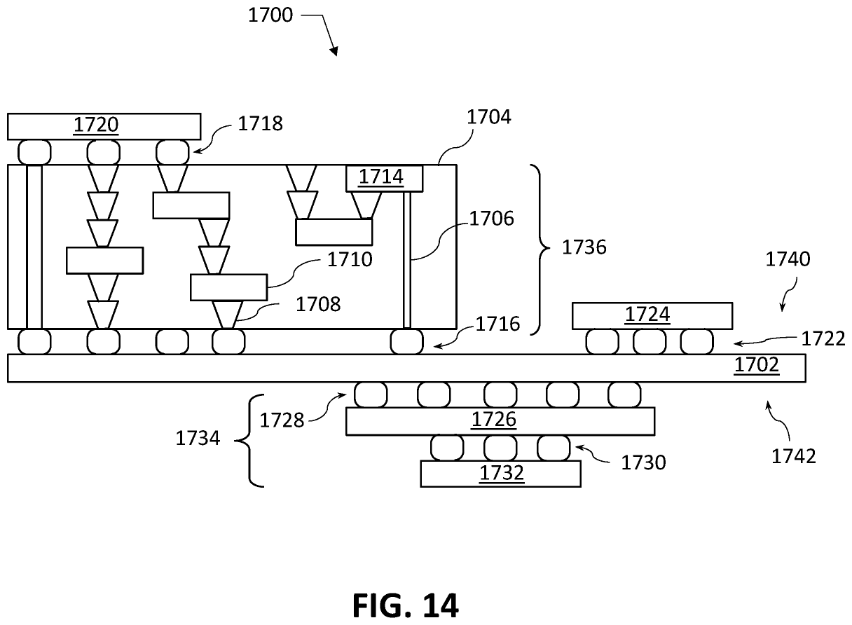

In this example, the substrate 1105 does not include routing under the base of the recess 1120. Instead, metal layers 1130, e.g., routing layers, are formed over the two inductor devices 240 and 1110. The metal layers 1130 may be similar to the metal layers (e.g., routing layers and/or interconnect layers) described in relation to FIGS. 13 and 14. Two dies 1140 and 1150 are mounted over the metal layers 1130. The dies 1140 and 1150 may include, for example, logic devices (e.g., transistors), memory devices, other passive devices (e.g., other inductors, capacitors, etc.), ferromagnetic devices, etc., or a combination of such devices. In this example, the die 1140 is coupled through the metal layers 1130 to the inductor device 240, and the die 1150 is coupled through the metal layers 1130 to the inductor device 1110. For example, the inductor device 240 may provide power regulation for the first die 1140, and the inductor device 1110 may provide power regulation for the second die 1150.

### Example Devices

The inductor devices disclosed herein may be included in any suitable electronic device. FIGS. 12-15 illustrate various examples of apparatuses that may include the one or more transistors disclosed herein, which may have been fabricated using the processes disclosed herein.

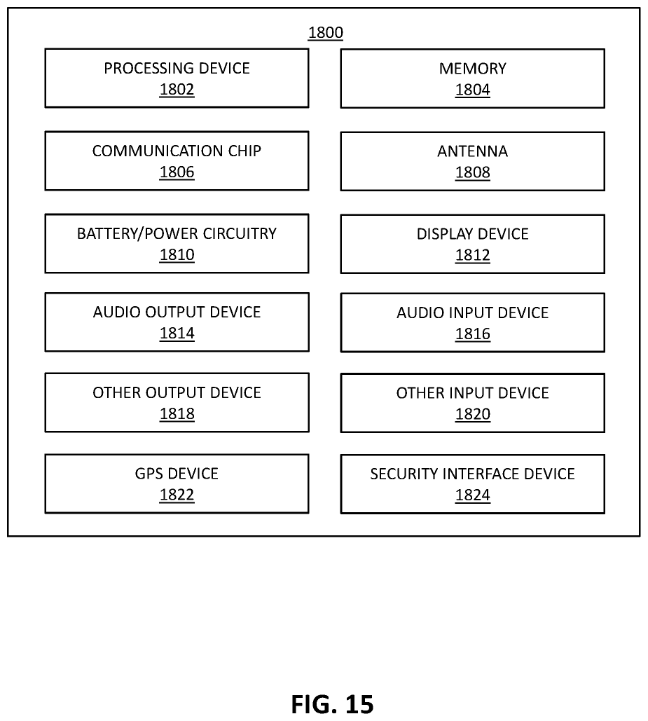

FIGS. 12A and 12B are top views of a wafer and dies that may include or be coupled to one or more inductor devices in accordance with any of the embodiments disclosed herein. The wafer 1500 may be composed of semiconductor material and may include one or more dies 1502 having IC structures formed on a surface of the wafer 1500. Each of the dies 1502 may be a repeating unit of a semiconductor product that includes any suitable IC structure (e.g., the IC structures as shown in any of FIGS. 2-14, or any further embodiments of the IC structures described herein). After the fabrication of the semiconductor product is complete (e.g., after manufacture of one or more IC structures with one or more of the transistors as described herein, included in a particular electronic component, e.g., in a transistor or in a memory device), the wafer 1500 may undergo a singulation process in which each of the dies 1502 is separated from one another to provide discrete “chips” of the semiconductor product. In particular, devices that include one or more of the transistors as disclosed herein may take the form of the wafer 1500 (e.g., not singulated) or the form of the die 1502 (e.g., singulated). The die 1502 may include one or more transistors (e.g., one or more of the transistors 1640 of FIG. 13, discussed below) and/or supporting circuitry to route electrical signals to the transistors, as well as any other IC components (e.g., one or more of the non-planar transistors described herein). In some embodiments, the wafer 1500 or the die 1502 may include a memory device (e.g., an SRAM device), a logic device (e.g., an AND, OR, NAND, or NOR gate), or any other suitable circuit element. Multiple ones of these devices may be combined on a single die 1502. For example, a memory array formed by multiple memory devices may be formed on a same die 1502 as a processing device (e.g., the processing device 1802 of FIG. 15) or other logic that is configured to store information in the memory devices or execute instructions stored in the memory array.

FIG. 13 is a cross-sectional side view of an IC device 1600 that may include or be coupled to one or more inductor devices in accordance with any of the embodiments disclosed herein. The IC device 1600 may be formed on a substrate 1602 (e.g., the wafer 1500 of FIG. 12A) and may be included in a die (e.g., the die 1502 of FIG. 12B). The substrate 1602 may be any substrate as described herein. The substrate 1602 may be part of a singulated die (e.g., the dies 1502 of FIG. 12B) or a wafer (e.g., the wafer 1500 of FIG. 12A).

The IC device 1600 may include one or more device layers 1604 disposed on the substrate 1602. The device layer 1604 may include features of one or more transistors 1640 (e.g., metal oxide semiconductor field-effect transistors (MOSFETs)) formed on the substrate 1602. The device layer 1604 may include, for example, one or more source and/or drain (S/D) regions 1620, a gate 1622 to control current flow in the transistors 1640 between the S/D regions 1620, and one or more S/D contacts 1624 to route electrical signals to/from the S/D regions 1620. The transistors 1640 may include additional features not depicted for the sake of clarity, such as device isolation regions, gate contacts, and the like. The transistors 1640 are not limited to the type and configuration depicted in FIG. 13 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon and nanowire transistors.

Each transistor 1640 may include a gate 1622 formed of at least two layers, a gate electrode layer and a gate dielectric layer.

The gate electrode layer may be formed on the gate interconnect support layer and may consist of at least one P-type workfunction metal or N-type workfunction metal, depending on whether the transistor is to be a PMOS or an NMOS transistor, respectively. In some implementations, the gate electrode layer may consist of a stack of two or more metal layers, where one or more metal layers are workfunction metal layers and at least one metal layer is a fill metal layer. Further metal layers may be included for other purposes, such as a barrier layer or/and an adhesion layer.

For a PMOS transistor, metals that may be used for the gate electrode include, but are not limited to, ruthenium, palladium, platinum, cobalt, nickel, and conductive metal oxides, e.g., ruthenium oxide. A P-type metal layer will enable the formation of a PMOS gate electrode with a workfunction that is between about 4.9 electron Volts (eV) and about 5.2 eV. For an NMOS transistor, metals that may be used for the gate electrode include, but are not limited to, hafnium, zirconium, titanium, tantalum, aluminum, alloys of these metals, and carbides of these metals such as hafnium carbide, zirconium carbide, titanium carbide, tantalum carbide, aluminum carbide, tungsten, tungsten carbide. An N-type metal layer will enable the formation of an NMOS gate electrode with a workfunction that is between about 3.9 eV and about 4.2 eV.

In some embodiments, when viewed as a cross section of the transistor 1640 along the source-channel-drain direction, the gate electrode may be formed as a U-shaped structure that includes a bottom portion substantially parallel to the surface of the substrate and two sidewall portions that are substantially perpendicular to the top surface of the substrate. In other embodiments, at least one of the metal layers that form the gate electrode may simply be a planar layer that is substantially parallel to the top surface of the substrate and does not include sidewall portions substantially perpendicular to the top surface of the substrate. In other embodiments, the gate electrode may be implemented as a combination of U-shaped structures and planar, non-U-shaped structures. For example, the gate electrode may be implemented as one or more U-shaped metal layers formed atop one or more planar, non-U-shaped layers. In some embodiments, the gate electrode may consist of a V-shaped structure (e.g., when a fin of a FinFET transistor does not have a “flat” upper surface, but instead has a rounded peak).

Generally, the gate dielectric layer of a transistor 1640 may include one layer or a stack of layers, and the one or more layers may include silicon oxide, silicon dioxide, and/or a high-k dielectric material. The high-k dielectric material included in the gate dielectric layer of the transistor 1640 may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric layer include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric layer to improve its quality when a high-k material is used.

The S/D regions 1620 may be formed within the substrate 1602 adjacent to the gate 1622 of each transistor 1640, using any suitable processes known in the art. For example, the S/D regions 1620 may be formed using either an implantation/diffusion process or a deposition process. In the former process, dopants such as boron, aluminum, antimony, phosphorous, or arsenic may be ion-implanted into the substrate 1602 to form the S/D regions 1620. An annealing process that activates the dopants and causes them to diffuse farther into the substrate 1602 may follow the ion implantation process. In the latter process, an epitaxial deposition process may provide material that is used to fabricate the S/D regions 1620. In some implementations, the S/D regions 1620 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1620 may be formed using one or more alternate semiconductor materials such as germanium or a group III-V material or alloy. In further embodiments, one or more layers of metal and/or metal alloys may be used to form the S/D regions 1620. In some embodiments, an etch process may be performed before the epitaxial deposition to create recesses in the substrate 1602 in which the material for the S/D regions 1620 is deposited.

Electrical signals, such as power and/or input/output (I/O) signals, may be routed to and/or from the transistors 1640 of the device layer 1604 through one or more interconnect layers disposed on the device layer 1604 (illustrated in FIG. 13 as interconnect layers 1606-1610). For example, electrically conductive features of the device layer 1604 (e.g., the gate 1622 and the S/D contacts 1624) may be electrically coupled with the interconnect structures 1628 of the interconnect layers 1606-1610. The one or more interconnect layers 1606-1610 may form an ILD stack 1619 of the IC device 1600.

The interconnect structures 1628 may be arranged within the interconnect layers 1606-1610 to route electrical signals according to a wide variety of designs (in particular, the arrangement is not limited to the particular configuration of interconnect structures 1628 depicted in FIG. 13). Although a particular number of interconnect layers 1606-1610 is depicted in FIG. 13, embodiments of the present disclosure include IC devices having more or fewer interconnect layers than depicted.

In some embodiments, the interconnect structures 1628 may include trench contact structures 1628a (sometimes referred to as “lines”) and/or via structures 1628b (sometimes referred to as “holes”) filled with an electrically conductive material such as a metal. The trench contact structures 1628a may be arranged to route electrical signals in a direction of a plane that is substantially parallel with a surface of the substrate 1602 upon which the device layer 1604 is formed. For example, the trench contact structures 1628a may route electrical signals in a direction in and out of the page from the perspective of FIG. 13. The via structures 1628b may be arranged to route electrical signals in a direction of a plane that is substantially perpendicular to the surface of the substrate 1602 upon which the device layer 1604 is formed. In some embodiments, the via structures 1628b may electrically couple trench contact structures 1628a of different interconnect layers 1606-1610 together.

The interconnect layers 1606-1610 may include a dielectric material 1626 disposed between the interconnect structures 1628, as shown in FIG. 13. The dielectric material 1626 may take the form of any of the embodiments of the dielectric material provided between the interconnects of the IC structures disclosed herein.

In some embodiments, the dielectric material 1626 disposed between the interconnect structures 1628 in different ones of the interconnect layers 1606-1610 may have different compositions. In other embodiments, the composition of the dielectric material 1626 between different interconnect layers 1606-1610 may be the same.

A first interconnect layer 1606 (referred to as Metal 1 or “M1”) may be formed directly on the device layer 1604. In some embodiments, the first interconnect layer 1606 may include trench contact structures 1628a and/or via structures 1628b, as shown. The trench contact structures 1628a of the first interconnect layer 1606 may be coupled with contacts (e.g., the S/D contacts 1624) of the device layer 1604.

A second interconnect layer 1608 (referred to as Metal 2 or “M2”) may be formed directly on the first interconnect layer 1606. In some embodiments, the second interconnect layer 1608 may include via structures 1628b to couple the trench contact structures 1628a of the second interconnect layer 1608 with the trench contact structures 1628a of the first interconnect layer 1606. Although the trench contact structures 1628a and the via structures 1628b are structurally delineated with a line within each interconnect layer (e.g., within the second interconnect layer 1608) for the sake of clarity, the trench contact structures 1628a and the via structures 1628b may be structurally and/or materially contiguous (e.g., simultaneously filled during a dual-damascene process) in some embodiments.

A third interconnect layer 1610 (referred to as Metal 3 or “M3”) (and additional interconnect layers, as desired) may be formed in succession on the second interconnect layer 1608 according to similar techniques and configurations described in connection with the second interconnect layer 1608 or the first interconnect layer 1606.

The IC device 1600 may include a solder resist material 1634 (e.g., polyimide or similar material) and one or more bond pads 1636 formed on the interconnect layers 1606-1610. The bond pads 1636 may be electrically coupled with the interconnect structures 1628 and configured to route the electrical signals of the transistor(s) 1640 to other external devices. For example, solder bonds may be formed on the one or more bond pads 1636 to mechanically and/or electrically couple a chip including the IC device 1600 with another component (e.g., a circuit board). The IC device 1600 may have other alternative configurations to route the electrical signals from the interconnect layers 1606-1610 than depicted in other embodiments. For example, the bond pads 1636 may be replaced by or may further include other analogous features (e.g., posts) that route the electrical signals to external components.

FIG. 14 is a cross-sectional side view of an IC device assembly 1700 that may include one or more inductor devices in accordance with any of the embodiments disclosed herein. The IC device assembly 1700 includes a number of components disposed on a circuit board 1702 (which may be, e.g., a motherboard). The IC device assembly 1700 includes components disposed on a first face 1740 of the circuit board 1702 and an opposing second face 1742 of the circuit board 1702; generally, components may be disposed on one or both faces 1740 and 1742. In particular, any suitable ones of the components of the IC device assembly 1700 may include one or more of the non-planar transistors disclosed herein.

In some embodiments, the circuit board 1702 may be a printed circuit board (PCB) including multiple metal layers separated from one another by layers of dielectric material and interconnected by electrically conductive vias. Any one or more of the metal layers may be formed in a desired circuit pattern to route electrical signals (optionally in conjunction with other metal layers) between the components coupled to the circuit board 1702. In other embodiments, the circuit board 1702 may be a non-PCB substrate.

The IC device assembly 1700 illustrated in FIG. 14 includes a package-on-interposer structure 1736 coupled to the first face 1740 of the circuit board 1702 by coupling components 1716. The coupling components 1716 may electrically and mechanically couple the package-on-interposer structure 1736 to the circuit board 1702 and may include solder balls (as shown in FIG. 14), male and female portions of a socket, an adhesive, an underfill material, and/or any other suitable electrical and/or mechanical coupling structure.

The package-on-interposer structure 1736 may include an IC package 1720 coupled to an interposer 1704 by coupling components 1718. The coupling components 1718 may take any suitable form for the application, such as the forms discussed above with reference to the coupling components 1716. Although a single IC package 1720 is shown in FIG. 14, multiple IC packages may be coupled to the interposer 1704; indeed, additional interposers may be coupled to the interposer 1704. The interposer 1704 may provide an intervening substrate used to bridge the circuit board 1702 and the IC package 1720. The IC package 1720 may be or include, for example, a die (the die 1502 of FIG. 12B), an IC device (e.g., the IC device 1600 of FIG. 13), or any other suitable component. In some embodiments, the IC package 1720 may be or include one or more inductor devices, as described herein. Generally, the interposer 1704 may spread a connection to a wider pitch or reroute a connection to a different connection. For example, the interposer 1704 may couple the IC package 1720 (e.g., a die) to a ball grid array (BGA) of the coupling components 1716 for coupling to the circuit board 1702. In the embodiment illustrated in FIG. 14, the IC package 1720 and the circuit board 1702 are attached to opposing sides of the interposer 1704; in other embodiments, the IC package 1720 and the circuit board 1702 may be attached to a same side of the interposer 1704. In some embodiments, three or more components may be interconnected by way of the interposer 1704.

The interposer 1704 may be formed of an epoxy resin, a fiberglass-reinforced epoxy resin, a ceramic material, or a polymer material such as polyimide. In some implementations, the interposer 1704 may be formed of alternate rigid or flexible materials that may include the same materials described above for use in a semiconductor substrate, such as silicon, germanium, and other group III-V and group IV materials. The interposer 1704 may include metal interconnects 1708 and vias 1710, including but not limited to TSVs 1706. The interposer 1704 may further include embedded devices 1714, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency (RF) devices, power amplifiers, power management devices, antennas, arrays, sensors, and microelectromechanical systems (MEMS) devices may also be formed on the interposer 1704. The package-on-interposer structure 1736 may take the form of any of the package-on-interposer structures known in the art.

The IC device assembly 1700 may include an IC package 1724 coupled to the first face 1740 of the circuit board 1702 by coupling components 1722. The coupling components 1722 may take the form of any of the embodiments discussed above with reference to the coupling components 1716, and the IC package 1724 may take the form of any of the embodiments discussed above with reference to the IC package 1720.

The IC device assembly 1700 illustrated in FIG. 14 includes a package-on-package structure 1734 coupled to the second face 1742 of the circuit board 1702 by coupling components 1728. The package-on-package structure 1734 may include an IC package 1726 and an IC package 1732 coupled together by coupling components 1730 such that the IC package 1726 is disposed between the circuit board 1702 and the IC package 1732. The coupling components 1728 and 1730 may take the form of any of the embodiments of the coupling components 1716 discussed above, and the IC packages 1726 and 1732 may take the form of any of the embodiments of the IC package 1720 discussed above. The package-on-package structure 1734 may be configured in accordance with any of the package-on-package structures known in the art.

FIG. 15 is a block diagram of an example computing device 1800 that may include one or more components one or more inductor devices in accordance with any of the embodiments disclosed herein. For example, any suitable ones of the components of the computing device 1800 may include an inductor device as described herein. Any one or more of the components of the computing device 1800 may include, or be included in, an IC device 1600 (FIG. 13). Any one or more of the components of the computing device 1800 may include, or be included in, an IC device assembly 1700 (FIG. 14).

A number of components are illustrated in FIG. 15 as included in the computing device 1800, but any one or more of these components may be omitted or duplicated, as suitable for the application. In some embodiments, some or all of the components included in the computing device 1800 may be attached to one or more motherboards. In some embodiments, some or all of these components are fabricated onto a single system-on-a-chip (SoC) die.

Additionally, in various embodiments, the computing device 1800 may not include one or more of the components illustrated in FIG. 14, but the computing device 1800 may include interface circuitry for coupling to the one or more components. For example, the computing device 1800 may not include a display device 1806, but may include display device interface circuitry (e.g., a connector and driver circuitry) to which a display device 1806 may be coupled. In another set of examples, the computing device 1800 may not include an audio input device 1824 or an audio output device 1808 but may include audio input or output device interface circuitry (e.g., connectors and supporting circuitry) to which an audio input device 1824 or audio output device 1808 may be coupled.

The computing device 1800 may include a processing device 1802 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1802 may include one or more digital signal processors (DSPs), application-specific ICs (ASICs), central processing units (CPUs), graphics processing units (GPUs), cryptoprocessors (specialized processors that execute cryptographic algorithms within hardware), server processors, or any other suitable processing devices. The computing device 1800 may include a memory 1804, which may itself include one or more memory devices such as volatile memory (e.g., dynamic random-access memory (DRAM)), nonvolatile memory (e.g., read-only memory (ROM)), flash memory, solid state memory, and/or a hard drive. In some embodiments, the memory 1804 may include memory that shares a die with the processing device 1802. This memory may be used as cache memory and may include embedded dynamic random-access memory (eDRAM) or spin transfer torque magnetic random-access memory (STT-MRAM).

In some embodiments, the computing device 1800 may include a communication chip 1812 (e.g., one or more communication chips). For example, the communication chip 1812 may be configured for managing wireless communications for the transfer of data to and from the computing device 1800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 1812 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication chip 1812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1812 may operate in accordance with other wireless protocols in other embodiments. The computing device 1800 may include an antenna 1822 to facilitate wireless communications and/or to receive other wireless communications (such as AM or FM radio transmissions).

In some embodiments, the communication chip 1812 may manage wired communications, such as electrical, optical, or any other suitable communication protocols (e.g., the Ethernet). As noted above, the communication chip 1812 may include multiple communication chips. For instance, a first communication chip 1812 may be dedicated to shorter-range wireless communications such as Wi-Fi or Bluetooth, and a second communication chip 1812 may be dedicated to longer-range wireless communications such as global positioning system (GPS), EDGE, GPRS, CDMA, WiMAX, LTE, EV-DO, or others. In some embodiments, a first communication chip 1812 may be dedicated to wireless communications, and a second communication chip 1812 may be dedicated to wired communications.

The computing device 1800 may include battery/power circuitry 1814. The battery/power circuitry 1814 may include one or more energy storage devices (e.g., batteries or capacitors) and/or circuitry for coupling components of the computing device 1800 to an energy source separate from the computing device 1800 (e.g., AC line power).

The computing device 1800 may include a display device 1806 (or corresponding interface circuitry, as discussed above). The display device 1806 may include any visual indicators, such as a heads-up display, a computer monitor, a projector, a touchscreen display, a liquid crystal display (LCD), a light-emitting diode display, or a flat panel display, for example.

The computing device 1800 may include an audio output device 1808 (or corresponding interface circuitry, as discussed above). The audio output device 1808 may include any device that generates an audible indicator, such as speakers, headsets, or earbuds, for example.

The computing device 1800 may include an audio input device 1824 (or corresponding interface circuitry, as discussed above). The audio input device 1824 may include any device that generates a signal representative of a sound, such as microphones, microphone arrays, or digital instruments (e.g., instruments having a musical instrument digital interface (MIDI) output).

The computing device 1800 may include a GPS device 1818 (or corresponding interface circuitry, as discussed above). The GPS device 1818 may be in communication with a satellite-based system and may receive a location of the computing device 1800, as known in the art.

The computing device 1800 may include an other output device 1810 (or corresponding interface circuitry, as discussed above). Examples of the other output device 1810 may include an audio codec, a video codec, a printer, a wired or wireless transmitter for providing information to other devices, or an additional storage device.

The computing device 1800 may include an other input device 1820 (or corresponding interface circuitry, as discussed above). Examples of the other input device 1820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1800 may have any desired form factor, such as a hand-held or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device. In some embodiments, the computing device 1800 may be any other electronic device that processes data.

### Select Examples

The following paragraphs provide various examples of the embodiments disclosed herein.

Example 1 provides an inductor device that includes a conductive region; and a magnetic region including a magnetic material, the magnetic region extending in parallel to the conductive region in a first direction, the magnetic region having a height extending along the first direction and a width perpendicular to the first direction, the height at least five times greater than the width.

Example 2 provides the inductor device of example 1, where the magnetic material includes a ferromagnetic element, and a concentration by weight of the ferromagnetic element in the magnetic material is at least 80%.

Example 3 provides the inductor device of example 1 or 2 where the magnetic material includes less than 1% carbon and oxygen by weight.

Example 4 provides the inductor device of any of the preceding examples, where the magnetic material is an electroplated material.

Example 5 provides the inductor device of any of the preceding examples, further including a seed layer along a base of the magnetic region, the seed layer including a metal.

Example 6 provides the inductor device of example 5, where the seed layer includes copper.

Example 7 provides the inductor device of example 5, where the seed layer includes at least one of ruthenium, titanium, cobalt, and nickel.

Example 8 provides the inductor device of any of examples 5-7, where the seed layer further extends along a side of the magnetic region, the side of the magnetic region perpendicular to the base of the magnetic region.

Example 9 provides the inductor device of example 8, where the seed layer further extends over a top of the conductive region, the seed layer over the top of the conductive region separated from the conductive region by a dielectric material.

Example 10 provides the inductor device of any of the preceding examples, further including a conductive pad below the conductive region, the conductive region having a second width, and the conductive pad having a third width, the third width greater than the second width.

Example 11 provides the inductor device of any of the preceding examples, where the height is at least ten times greater than the width.

Example 12 provides the inductor device of any of the preceding examples, where, in a cross-section of the inductor device, the magnetic region is a first magnetic region, the inductor device includes a second magnetic region, the conductive region arranged between the first magnetic region and the second magnetic region.

Example 13 provides a device package that includes a support structure; an inductor device bonded to the support structure; and an IC die including a plurality of transistor devices, the IC die bonded to one of the support structure and the inductor device, the IC die electrically coupled to the inductor device.

Example 14 provides the device package of example 13, where the inductor device is a first inductor device, the device package further including a second inductor device bonded to the support structure.

Example 15 provides the device package of example 14, where the first inductor device has a first length extending in a direction parallel to the support structure, and the second inductor device has a second length extending in the direction parallel to the support structure, the second length different from the first length.

Example 16 provides the device package of any of examples 13-15, where the inductor device is a first inductor device, the support structure has a first face and a second face opposite the first face, the first inductor device is bonded to the first face of the support structure, and a second inductor device is bonded to the second face of the support structure.

Example 17 provides the device package of example 16, further including a conductive structure extending through the support structure, the conductive structure coupled to the first inductor device at the first face and to the second inductor device at the second face.

Example 18 provides the device package of example 13, where the inductor device is a first inductor device, the device package further including a second inductor device bonded to the first inductor device.

Example 19 provides the device package of example 18, where the first inductor device includes a first magnetic region and the second inductor device includes a second magnetic region, the first magnetic region and the second magnetic region are coupled.

Example 20 provides the device package of example 19, where a solder ball couples the first magnetic region to the second magnetic region.

Example 21 provides the device package of example 19, where the first inductor device and the second inductor device are coupled via hybrid bonding, and the first magnetic region is physically connected to the second magnetic region.

Example 22 provides the device package of example 13, where the support structure has a recess, and the inductor device is in the recess.

Example 23 provides a method for fabricating an inductor device, where the method includes providing a release layer over a support structure; depositing a seed layer over a release layer; electroplating a magnetic material over portions of the seed layer, the magnetic material forming at least one magnetic region; depositing a conductive material over the seed layer, the conductive material forming at least one conductive region; and releasing the inductor device from the support structure along the release layer, the inductor device including the seed layer, the at least one magnetic region, and the at least one conductive region.

Example 24 provides the method of example 23, further including depositing a conductive pad over the seed layer, where a particular conductive region is formed over the conductive pad.

Example 25 provides the method of example 24, further including depositing a second conductive pad over the particular conductive region.

Example 26 provides the method of any of examples 23-25, further including bonding the inductor device to a second support structure.

Example 27 provides an IC package that includes an IC die, including one or more of the IC devices according to any one of the preceding examples. The IC package may also include a further component, coupled to the IC die.

Example 28 provides the IC package according to example 27, where the further component is one of a package substrate, a flexible substrate, or an interposer.

Example 29 provides the IC package according to examples 27 or 28, where the further component is coupled to the IC die via one or more first level interconnects.

Example 30 provides the IC package according to example 29, where the one or more first level interconnects include one or more solder bumps, solder posts, or bond wires.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An inductor device comprising:
a conductive region; and
a magnetic region comprising a magnetic material, the magnetic region extending in parallel to the conductive region in a first direction, the magnetic region having a height extending along the first direction and a width perpendicular to the first direction, the height at least five times greater than the width.

2. The inductor device of claim 1, wherein the magnetic material comprises a ferromagnetic element, and a concentration by weight of the ferromagnetic element in the magnetic material is at least 80%.

3. The inductor device of claim 1, wherein the magnetic material includes less than 1% carbon and oxygen by weight.

4. The inductor device of claim 1, wherein the magnetic material is an electroplated material.

5. The inductor device of claim 1, further comprising a seed layer along a base of the magnetic region, the seed layer comprising a metal.

6. The inductor device of claim 5, wherein the seed layer further extends along a side of the magnetic region, the side of the magnetic region perpendicular to the base of the magnetic region.

7. The inductor device of claim 6, wherein the seed layer further extends over a top of the conductive region, the seed layer over the top of the conductive region separated from the conductive region by a dielectric material.

8. The inductor device of claim 1, further comprising a conductive pad below the conductive region, the conductive region having a second width, and the conductive pad having a third width, the third width greater than the second width.

9. The inductor device of claim 1, wherein the height is at least ten times greater than the width.

10. A device package comprising:
a support structure;
an inductor device bonded to the support structure; and
an integrated circuit (IC) die comprising a plurality of transistor devices, the IC die bonded to one of the support structure and the inductor device, the IC die electrically coupled to the inductor device.

11. The device package of claim 10, wherein the inductor device is a first inductor device, the device package further comprising a second inductor device bonded to the support structure.

12. The device package of claim 11, wherein the first inductor device has a first length extending in a direction parallel to the support structure, and the second inductor device has a second length extending in the direction parallel to the support structure, the second length different from the first length.

13. The device package of claim 10, wherein the inductor device is a first inductor device, the support structure has a first face and a second face opposite the first face, the first inductor device is bonded to the first face of the support structure, and a second inductor device is bonded to the second face of the support structure.

14. The device package of claim 13, further comprising a conductive structure extending through the support structure, the conductive structure coupled to the first inductor device at the first face and to the second inductor device at the second face.

15. The device package of claim 10, wherein the inductor device is a first inductor device, the device package further comprising a second inductor device bonded to the first inductor device.

16. The device package of claim 15, wherein the first inductor device comprises a first magnetic region and the second inductor device comprises a second magnetic region, the first magnetic region and the second magnetic region are coupled.

17. The device package of claim 16, wherein the first inductor device and the second inductor device are coupled via hybrid bonding, and the first magnetic region is physically connected to the second magnetic region.

18. The device package of claim 10, wherein the support structure has a recess, and the inductor device is in the recess.

19. A method for fabricating an inductor device, the method comprising:
providing a release layer over a support structure;
depositing a seed layer over a release layer;
electroplating a magnetic material over portions of the seed layer, the magnetic material forming at least one magnetic region;
depositing a conductive material over the seed layer, the conductive material forming at least one conductive region; and
releasing the inductor device from the support structure along the release layer, the inductor device comprising the seed layer, the at least one magnetic region, and the at least one conductive region.

20. The method of claim 19, further comprising bonding the inductor device to a second support structure.
